(19) United States
(12) Patent Application Publication
(10) Pub. No.: US 2008/0284568 A1
(43) Pub. Date: Nov. 20, 2008

(54) Transponder

(75) Inventor: Balbir Kumar, London (GB)

Correspondence Address: KENYON & KENYON LLP, ONE BROADWAY, NEW YORK, NY, 10004, US

(73) Assignee: BAE Systems PLC, London (GB)

(21) Appl. No.: 11/547,773

(22) PCT Filed: Jul. 5, 2006
(86) PCT No.: PCT/GB2006/050189

§ 371 Date: Oct. 4, 2006

(30) Foreign Application Priority Data
Jul. 28, 2005 (GB) 0515523.9

(51) Int. Cl. H04Q 5/22

(52) U.S. Cl. 340/10.1

(57) ABSTRACT

A transporter is provided for use in particular with microwave or millimetric wavelength electromagnetic radiation, and includes a retro-reflecting arrangement and a modulating arrangement, in which the modulating arrangement is operable, by a current-induced field, to apply a predetermined type of pattern of modulation to incident microwave or millimetric wavelength electromagnetic radiation passing therethrough, before and/or after the incident radiation is reflected by the retro-reflecting arrangement. When used in combination with an interrofator unit, a particular type or pattern of modulation applied by the transponder may be detected in order to extract information represented in the modulation.

This invention relates to transponders of electromagnetic radiation and in particular, though not exclusively, to a transponder comprising a retro-reflector and modulator for use in modulating and reflecting incident electromagnetic radiation of microwave, millimetric or optical wavelengths.

The term “microwave” is generally understood to refer to that part of the electromagnetic spectrum between infra-red radiation and radio waves. Typically, this is stated to be substantially in the frequency range 1 to 300 GHz, although sometimes it is stated to be in the frequency range 0.2 to 300 GHz. This range includes that part of the spectrum referred to as “millimetric wave”, which is generally stated to have a frequency in the range 30 to 300 GHz.

It is known to use an opto-electronic device to modulate incident laser light in a predetermined way for the purpose of remotely identifying a host of the opto-electronic device as being of one predefined type or another. In particular, it is known to use a modulatable retro-reflector comprising a combination of prisms or mirrors as reflectors, at least one of which can be electro-mechanically moved, for example by piezoelectric actuators, to modulate incident light by changes in the total reflection of the retro-reflector. However, the range of use of optical systems is limited by the weather and atmospheric conditions. Moreover, known optical modulatable reflectors are relatively complex and expensive, particularly those designed for mounting on vehicles that are subject to vibration and contamination by dirt and oil.

From a first aspect, the present invention resides in a transponder, comprising retro-reflecting means and modulating means, wherein the modulating means are operable, by means of a current-induced field, to apply a predetermined type or pattern of modulation to incident microwave or millimetric wavelength electromagnetic radiation passing therethrough, before and/or after the incident radiation is reflected by said retro-reflecting means.

Advantageously, preferred embodiments of the present invention are able to provide a simple and low cost transponder operable to add information to an incoming electromagnetic signal, for example an “interrogator” signal, and to return the modulated signal to a source of the signal along a substantially similar path to that along which it came. The information added by the transponder may relate to anything, but preferably is of a predetermined type or pattern and may be conveyed using one of a number of different types of modulation.

Preferably, the retro-reflecting means are essentially “passive” in that their role is purely one of reflecting electromagnetic radiation whether already modulated or not. The function of the modulating means is preferably separate and distinct from the function of the retro-reflecting means, even where the two means are combined in a single device.

In a preferred embodiment of the present invention, the modulating means are operable to apply a fixed type or pattern of modulation to incident electromagnetic radiation. Preferably, this type of modulating means is interchangeable according to the type or pattern of modulation to be applied. Alternatively, the transponder further comprises a modulating signal generator operable to output a modulating signal to the modulating means and wherein the modulating means are responsive to the modulating signal to apply a corresponding type or pattern of modulation to incident electromagnetic radiation passing therethrough.

The modulating means may comprise a Faraday rotator operable to rotate the angle of polarisation of incident linearly polarised electromagnetic radiation passing therethrough. Alternatively, the modulating means may apply other forms or modulation, in particular: to alter the phase of incident circularly polarised electromagnetic radiation passing therethrough; to alter the direction of incident circularly polarised electromagnetic radiation passing therethrough; or to alter the amplitude of incident electromagnetic radiation passing therethrough.

Any of these preferred forms of modulation may be applied by a transponder according to preferred embodiments of the present invention in which the modulating means comprise a portion of magnetic material such as ferrite and wherein the current-induced field is generated in the portion of magnetic material by means of one or more conducting wires. The one or more conducting wires may be are embedded within the portion of magnetic material and, if so, may be arranged in a plane substantially parallel arrangement, for example in a grid-like arrangement. Alternatively, the one or more conducting wires are arranged in the form of a coil.

Preferably, the retro-reflecting means and the modulating means are combined in a single device.

In a preferred embodiment, the transponder further comprises means to recognise a predetermined characteristic in incident electromagnetic radiation and means responsive to that recognition to enable or to disable the modulating means. This features improves power conservation at the transponder and also enables covert applications.

In a preferred embodiment or the present invention, a number of transponders according to this first aspect of the present invention may be deployed as part of a system that further comprises an interrogator unit operable to act as the source of incident electromagnetic radiation. The main complexity and cost of the system may be reside in the interrogator unit, of which there may be relatively few in comparison to the number of transponders in a typical application of the system. The role of the interrogator unit is to send out interrogator signals towards the deployed transponders and to detect information conveyed in returned signals modulated by the transponders. Information may relate for example to a host conveying the transponder, for the purposes of identification, etc.

The transponder is a very simple device which incorporates a reflector and a free space microwave modulator that modulates incident radiation in a predetermined manner. The modulator may apply a fixed type or pattern of modulation to the incident radiation or the transponder may be provided with a modulation waveform generator that controls the modulator and which can be varied with time in a predetermined manner.

Preferably the retro-reflecting means comprise a corner reflector or a cluster of corner reflectors. Alternatively, the retro-reflecting means may comprise a conical reflector in combination with a planar reflector, the modulating means being positioned between the two types of reflector.

From a second aspect, the present invention resides in an apparatus comprising at least one transponder according to the first aspect of the present invention above, and an interrogator unit operable to receive a signal modulated by said at least one transponder and to detect the type or pattern of modulation therein. Preferably, the interrogator unit is a radar system and more preferably an automotive radar system wherein said at least one transponder is mounted on a fixed or mobile object.

Preferably, for certain types of application, the interrogator unit may be arranged to know the modulation type or sequence at any instant in time and may use this information to obtain correlation gain, to improve the signal to noise ratio. However, for close-range applications, for example automotive applications, this technique would not in general be necessary.

Preferred embodiments of the present invention will now be described, by way of example only, and with reference to the accompanying drawings of which:

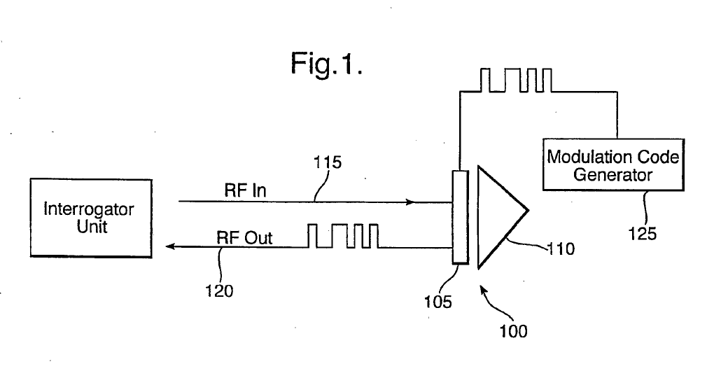

FIG. 1 illustrates the principle of operation of preferred embodiments of the present invention;

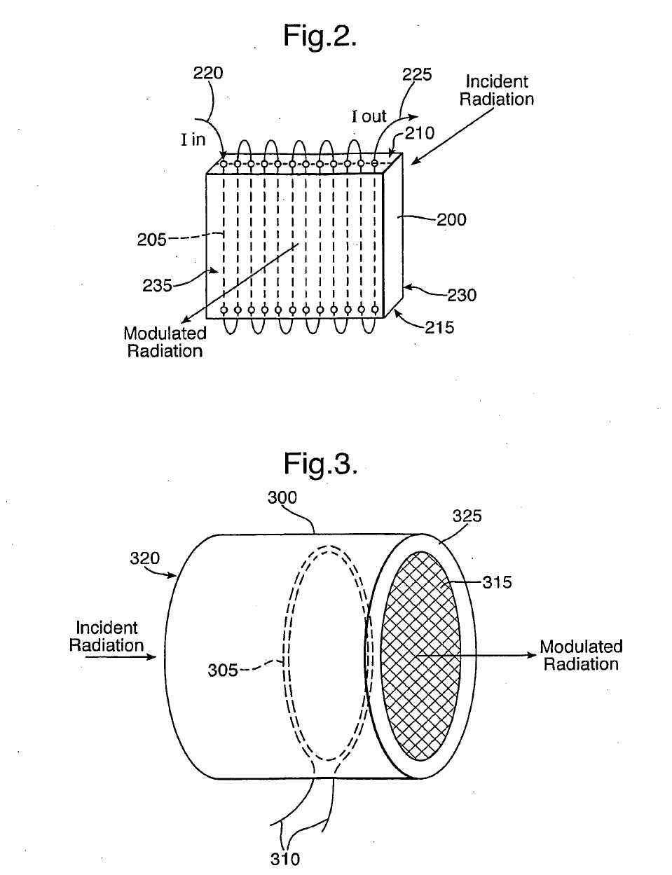

FIG. 2 shows one example of a free-space modulator device suitable for use in preferred embodiments of the present invention;

FIG. 3 shows another example of a free-space modulator device suitable for use in preferred embodiments of the present invention;

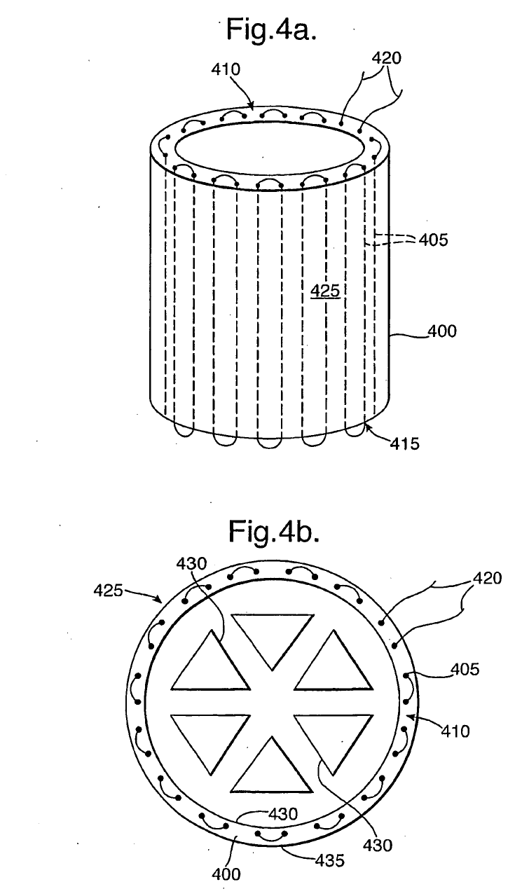

FIG. 4 shows a transponder according to a preferred embodiment of the present invention;

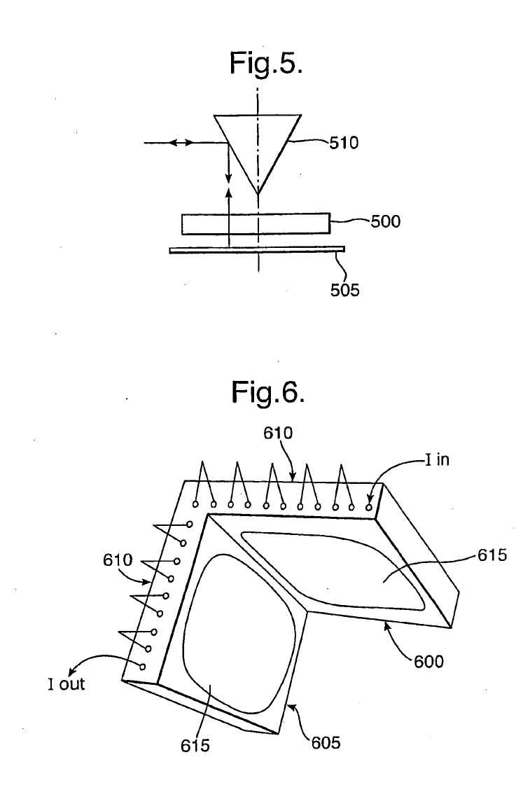

FIG. 5 shows a transponder according to a further preferred embodiment of the present invention; and

FIG. 6 shows a transponder according to a preferred embodiment of the present invention.

Preferred embodiments of the present invention operate according to the principles illustrated in outline in FIG. 1.

Referring to FIG. 1, a transponder 100 is shown comprising a free-space radio frequency (RF) modulator 1005 positioned adjacent to a retro-reflector 110, for example a corner-cube retro-reflector, and arranged to modulate an incident radio frequency electromagnetic signal 115, before or after reflection, or both, by the retro-reflector 110, so that the reflected signal 120 emerging from the transponder 100 includes a desired form of modulation. The retro-reflector 110 causes the reflected, modulated signal 120 to be directed back in the direction of the source 130 of the incident signal 115 where means may be provided to receive the modulated signal 120 and to mix the received signal 120 with the originally transmitted signal 115 to form a signal which can be further analysed to detect the applied form of modulation and hence any information conveyed by that modulation. The conveyed information may relate for example to the host carrying the transponder 100, identifying the host as “Friend” or “Foe” for example, or it may be of a more complex nature, providing more detailed information according to the application of the transponder. If there is relative motion between the source 130 of the signal 115 and the transponder 100, then standard techniques may be applied during processing of the modulated signal by the source 130 to take account of any Doppler shift present in the modulated signal 120.

Any one of a number of known types of free-space microwave or millimetric wave modulator device 105 may be used in a transponder 100 according to preferred embodiments of the present invention. The modulator 105 is selected according to the type of modulation that is to be applied to incident beams 115 of microwave or millimetric wavelength electromagnetic radiation. Examples of preferred modulators 105 are shown in FIGS. 2 and 3. Preferably, the modulator is of a type that modulates electromagnetic signals passing through it using a current-induced field, generated for example using one or more conducting wires that may be linked to a modulating current source.

Referring to FIG. 2, one particular known type of modulator is shown, in this example one operable to modulate by varying the divergence of, an incident beam of radiation. The modulator comprises a solid block of ferrite 200 in which are embedded in a planar arrangement a number of conducting wires 205, for example in parallel, as in FIG. 2, or in a crossed grid-like arrangement. Conveniently, the ferrite block 200 is made comparable in size to the aperture of the retro-reflector 110. Conveniently, the wires 205 are shown in FIG. 2 emerging from the ferrite block 200 along two edges 210, 215 so that they may be interconnected in a parallel, serial or other arrangement as required. A serial interconnection arrangement is shown in FIG. 2 by way of example. Alternatively, the wires may be linked or looped within the ferrite block 200 leaving only the lead-out wires 220, 225 emerging from the block 200. When an energising current is applied to the lead-out wires 220, 225, the magnetic field generated in the ferrite block 200 causes an incident beam of electromagnetic radiation passing through the block 200, at right-angles to the plane of the wires 205, to diverge to a greater or lesser extent according to the strength of the field. Thus the degree of divergence of the incident beam may be altered by varying the applied current, for example in a time varying fashion, to modulate the beam. Preferably, given that ferrite has a high dielectric constant, it is advantageous to apply a conventional anti-reflective coating, a microwave-absorbent coating for example, to each of the faces 230, 235 where the incident radiation enters and exits the block 200.

Referring to FIG. 3, another known type of modulator is shown, in this example a Faraday rotator operable to modulate by varying the angle of polarisation of an incident linearly polarised beam of radiation. Alternatively, if the incident radiation is circular-polarised, the Faraday rotator modulates the beam by altering its phase. The modulator comprises a solid cylindrical block of ferrite 300 having at least one circular coil 305 of conducting wire embedded within the ferrite cylinder 300 and arranged coaxially with the cylinder 300. Conveniently, the ferrite cylinder 300 is made comparable in diameter to the aperture of the retro-reflector 110. An incident beam of electromagnetic radiation enters the ferrite cylinder 300 substantially parallel to the axis of the cylinder. As with the modulator of FIG. 2, an anti-reflective coating 315 is applied to the faces 320, 325 where the incident radiation enters and exits the ferrite cylinder 300.

Other types of known modulator suitable for use in the transponder 105 include one operable to alter the direction of an incident beam of microwave or millimetric wavelength electromagnetic radiation. Such a beam-steering device has been described for example in European patent number EP 1027752 by the present applicants. Further types of suitable modulator include:

(a) a grid of diodes, for example as described by Jiang, F., Berk, W., Chen, Z.-T., Duncan, S., Qin, X.-H., Tu, D. W., Zhang, W.-M., Domier, C. W. and Luhmann, N. C. Jr. in “High-speed monolithic millimeter-wave switch array”, Microwave and Guided Wave Letters, IEEE (see also IEEE Microwave and Wireless Components Letters), March 1998, Volume: 8, Issue: 3, pages 112-114 or by Lam, W. W., Jou, C. F., Chen, H. Z., Stolt, K. S., Luhmann, N. C. Jr. and Rutledge, D. B. in. “Millimeter-wave diode-grid phase shifters”, IEEE Transactions on Microwave Theory and Techniques, May 1988, Volume 36, Issue 5, pages 902-907;

(b) a liquid crystal device as described by Tanaka, M. and Sato, S. in “Focusing properties of liquid crystal lens cells with stack-layered structure in the millimeter-wave region”, Microwave and Wireless Components Letters, IEEE (see also IEEE Microwave and Guided Wave Letters), May 2002, Volume 12, Issue 5, pages 163-165 or by Kamoda, H., Kuki, T., Fujikake, H. and Nomoto, T. in “Millimeter-wave beam former using liquid crystal”, 34th European Microwave Conference, 11-15 Oct. 2004, Volume 3, pages 1141-1144; or

(c) a RF micro-electrical-mechanical (MEM) device as described by Zhang, W.-K., Fan Jiang, Domier, C. W. and Luhmann, N. C. Jr. in “Quasi-optical E-band MEMS switching arrays”, Microwave Symposium Digest, 2002 IEEE MTT-S International, 2-7 Jun. 2002, Volume 3, pages 1531-1534.

In a further preferred embodiment of the present invention, a transponder will now be described with reference to FIG. 4. The transponder in this example incorporates a number of retro-reflectors within a cylindrical modulator operable to provide a substantially 3600 coverage in the azimuth plane.

Referring to FIG. 4a, a perspective view is provided of a transponder comprising a hollow ferrite cylinder 400 having an arrangement of parallel conducting wires 405 embedded within the ferrite of the cylinder 400 and running substantially parallel to the axis of the cylinder 400. Each wire emerges at the ends 410, 415 of the ferrite cylinder 400 to enable any desired interconnection arrangement to be applied between the wires, a serial interconnection arrangement being shown in FIG. 4a by way of example. A modulating current is applied through the lead-out wires 420 to generate a variable magnetic field within the ferrite 400, in a similar manner to that described above with reference to FIG. 2, so causing the degree of divergence of an incident beam of microwave or millimetric wavelength electromagnetic radiation to vary accordingly. An arrangement of six retro-reflectors (not shown in FIG. 4a), for example corner-cube reflectors, is placed inside the hollow ferrite cylinder 400 to reflect radiation entering the ferrite cylinder 400 through the side-wall 425.

Referring to FIG. 4b, an end view of the transponder of FIG. 4a is provided, showing, in particular, the arrangement of six corner-cube retro-reflectors 430 disposed in an axially symmetric arrangement within the cylinder 400. A greater or smaller number of retro-reflectors 430 can be arranged within the cylinder 400 as required, taking account of any interference effects that may arise between adjacent reflectors. Anti-reflective coatings 430, 435 are provided on the inner and outer walls of the cylinder 400.

The retro-reflectors 430 can be dihedral, bi-conical, trihedral, Vann Atta, Lunenburg or Burderhedral in shape, for example, as described by D. K. Barton and A. S. Leanov (Editors) in the book “Radar technology Encyclopaedia”, 1997 Artech House Inc, ISBN 0-89006-893-3. A corner reflector in particular has a broad angular response—a beam width of 42° is suggested in the above reference—and is widely used at microwave/millimetre wave frequencies. It is known, for example, that a ships' radar reflector normally contains a cluster of 6 corner reflectors to provide full 360° coverage in the azimuth plane. Angular response may be broadened by filling the retro-reflector, e.g. a corner-cube reflector, with a dielectric material such as high density polyethylene (HDPE).

In a further preferred embodiment of the present invention, another transponder capable of providing 360° coverage will now be described with reference to FIG. 5. The transponder in this embodiment avoids the use of retro-reflectors but would, in practise, be suited to relatively short-range applications, for example person-to-person identification applications.

Referring to FIG. 5, a modulator 500 of any one of the types described above, though preferably a Faraday rotator, is placed between a plane reflector 505 and a conical reflector 510. An incident beam of polarised microwave or millimetric wavelength electromagnetic radiation striking the conical reflector 510 is deflected by reflection through 90° and passes through the modulator 500. The modulator 500 applies a predetermined modulation to the incident beam whereupon, on emerging from the modulator 500, the beam is reflected by the plane reflector 505 back through the modulator 500 and thereafter by the conical reflector 510 along a similar line to that of the incident beam. While the use of a conical reflector 510 provides a full 360° of surrounding coverage, the range of use of this transponder may be limited in comparison with other embodiments of the present invention. However, limited range may not be a problem in short-range applications, such as person-to-person recognition applications, and may indeed be advantageous.

In a preferred application of transponders according to preferred embodiments of the present invention, a transponder is mounted on or otherwise associated with a host entity, be that a vehicle, a stationary object, person or animal or any other type of object that needs to be distinguished from other similar objects by remote interrogation. A modulation signal generator 125 is provided with each transponder 105 to provide a varying energising current to the modulator 105 so that the transponder 105 can apply the required modulation to any incident electromagnetic radiation. The type or pattern of modulation to be applied at any time by the modulation signal generator 125 may comply with standard modulating formats agreed according to the application so that a meaning assigned to each type or pattern of modulation can be recognised once the type or pattern of modulation has been identified in a received modulated signal.

At a remote monitoring position, an interrogator apparatus is provided to transmit a microwave or millimetric wave beam of electromagnetic radiation directed if necessary towards an entity to be interrogated. If the entity is provided with a transponder according to preferred embodiments of the present invention then the transmitted beam will pass through the modulator 105 and the modulated beam will be reflected from a retro-reflector arrangement 110, through the modulator 105 for a second time (optionally) and directed in substantially the reverse direction to that of the transmitted beam, towards the interrogator unit. The interrogator unit receives the modulated beam and determines whether any modulation has been applied to the beam and, if any, what type or pattern of modulation has been applied. The simplest interrogator architecture may be based upon a coherent detection system. However, such a configuration preferably incorporates an IQ detection network as described for example in “Coherent Radar Performance Estimation”, by James A Scheer and James L Kurtz (Artech House—ISBN 0-89006-628-0), and also preferably low-noise front-end amplifiers may or will be required.

A number of possible schemes can be envisaged for interpretation of detected modulation at the interrogator unit. Modulation types or patterns may be agreed in advance and may be time-dependent to maximise security or covertness and to aid interpretation of information conveyed in the modulation or to aid recognition of the transponder host. Detected modulation types or patterns may be compared with reference information stored or accessible at the interrogator unit.

The simplest waveform the interrogator unit needs to transmit is a continuous wave. However, the interrogator unit may also be arranged to transmit complicated waveforms such as a chirp or pulsed waveforms, as for example in a radar system, in order to obtain additional information regarding a host. These waveforms will also be modulated by the transponder in a slightly different manner, and may require a different processing technique to extract the modulating information imposed on the carrier by the transponder modulator. In particular, the interrogator unit will need to look for a modulation waveform in the return signals in the co-polar or the cross-polar channel (or both—it may have to look in both channels simultaneously), this depending on the geometry of the free-space modulator 105, the geometry of the reflector 110 and the polarisation of the originally transmitted electromagnetic radiation.

In a preferred embodiment of the present invention, a radar system, e.g. a frequency modulated and continuous waveform (F&CW) radar system, may be modified to detect modulation in radar return signals that may have been applied by a transponder according to preferred embodiments of the present invention. The radar system may detect such modulation by, for example, mixing a radar return signal with the original transmitted signal to generate a signal that may be processed further to extract information conveyed by that modulation. This arrangement may find particular application in automotive applications in which a conventional automotive radar may be modified to detect any modulation of the radar return signals that may have been applied by transponders according to the present invention located at mad-side locations on fixed objects such as bridges or roadway hazards, or mounted on other mobile vehicles. The modulation applied by such transponders may convey simple information relating of the types of objects on which they are mounted or of their location or the nature of the hazard that they represent, or the modulation may convey more complex data such as telemetric information relating to a mobile host or information forwarded from other sources as part of an information service, e.g. providing information on traffic congestion ahead, weather conditions and the like. As mentioned above, any Doppler shift arising from relative motion between elements of such a system may be taken account of using standard techniques when processing the signals.

Preferably, if linear polarisation is used in the transmitted beam from the interrogator unit, then wire grid polarisers placed before or after the modulator 105, or both before and after the modulator 105, may help to improve the depth of modulation achievable. The exact orientation of the grids and the number of grids will depend upon the polarisation of the transmitted beam, the modulator type and the geometry of the reflector 110.

In a further preferred embodiment of the present invention, the modulator 105 and the retro-reflector 110 may be combined into a single device made from the same material as the modulator 105, as shown for example in FIG. 6.

Referring to FIG. 6, a simple dihedral reflector is shown with both of the reflecting sections 600 and 605 being active, i.e. they can both modulate incident radiation, and both are constructed from ferrite materials. Each section 600, 605 has wires running through the ferrite and the reverse surfaces 610 are reflective of incident radiation. That is, they may comprise metal plates, or be coated with metallic paint, etc. Anti-reflecting coatings at the incidence faces 615 helps to reduce reflections form the air/ferrite interface.

The device shown in FIG. 6 will also work if only one of the sections 600, 605 of the dihedral is constructed from ferrite material (e.g. to save cost) and other section is purely a passive reflective surface, e.g. metal.

Preferably, any of the above transponder arrangements may be covered with a radome to protect the device against the environment and which may also be arranged to provide additional filtering of the incident radiation.

In order to conserve power or to make any of the above transponder embodiments more suited to covert applications, means may be provided at the transponder to detect incident electromagnetic radiation and to identify particular predetermined characteristics in the detected radiation. The transponder may be arranged to activate the modulation means for only so long as those characteristics are recognisable in the detected radiation. Such characteristics may include a particular level of incident signal power or particular types of signal or signal pattern representative, for example, of identifiable sources.

A “hostile” receiver might be able to detect a continuous wave (CW) transmission (i.e. a narrow frequency band transmission) by an interrogator unit over a relatively long range. This problem can be alleviated if the interrogator unit is arranged to transmit wide bandwidth or frequency-hopping signals so that the so-called hostile receive would be required to operate over a wide bandwidth and hence with reduced sensitivity.

1-19. (canceled)

20. A transponder, comprising:
a retro-reflecting arrangement; and
a modulating arrangement, wherein the modulating arrangement is operable, by a current-induced field, to apply a predetermined type or pattern of modulation to incident microwave or millimetric wavelength electromagnetic radiation passing therethrough, at least one of before and after the incident radiation is reflected by said retro-reflecting arrangement.

21. The transponder of claim 20, wherein the modulating arrangement is operable to apply one of a fixed type of modulation and a pattern of modulation to incident electromagnetic radiation.

22. The transponder of claim 21, wherein the modulating arrangement is interchangeable, and is selectable according to the type or pattern of modulation to be applied.

23. The transponder of claim 20, further comprising:
a modulating signal generator operable to output a modulating signal to the modulating arrangement, wherein the modulating arrangement is responsive to said modulating signal to apply one of a corresponding type of modulation and a pattern of modulation to incident electromagnetic radiation passing therethrough.

24. The transponder of claim 20, wherein the modulating arrangement includes a Faraday rotator operable to rotate an angle of polarization of incident linearly polarized electromagnetic radiation passing therethrough.

25. The transponder of claim 20, wherein the modulating arrangement is operable to alter a phase of incident circularly polarized electromagnetic radiation passing therethrough.

26. The transponder of claim 20, wherein the modulating arrangement is operable to alter a direction of incident circularly polarized electromagnetic radiation passing therethrough.

27. The transponder of claim 20, wherein the modulating arrangement is operable to alter an amplitude of incident electromagnetic radiation passing therethrough.

28. The transponder of claim 20, wherein the modulating arrangement includes a portion of magnetic material, and wherein the current-induced field is generated in said portion of magnetic material by at least one conducting wire.

29. The transponder of claim 28, wherein said at least one conducting wire is embedded within said portion of magnetic material.

30. The transponder of claim 29, wherein said at least one conducting wire is arranged in a substantially plane parallel arrangement.

31. The transponder of claim 30, wherein said at least one conducting wire is arranged in a grid-like arrangement.

32. The transponder of claim 29, wherein said at least one conducting wire is arranged in the form of a coil.

33. The transponder of claim 28, wherein said portion of magnetic material includes ferrite.

34. The transponder of claim 20, wherein the retro-reflecting arrangement and the modulating arrangement are combined in a single device.

35. The transponder of claim 20, further comprising:
a recognizing arrangement to recognize a predetermined characteristic in incident electromagnetic radiation; and
an enabling and disabling arrangement responsive to said recognition to enable or disable the modulating arrangement.

36. An apparatus comprising:
at least one transponder including:
a retro-reflecting arrangement; and
a modulating arrangement, wherein the modulating arrangement is operable, by a current-induced field, to apply a predetermined type or pattern of modulation to incident microwave or millimetric wavelength electromagnetic radiation passing therethrough, at least one of before and after the incident radiation is reflected by said retro-reflecting arrangement; and
an interrogator unit operable to receive a signal modulated by said at least one transponder and to detect one of a type of modulation and a pattern of modulation therein.

37. The apparatus of claim 36, wherein said interrogator unit includes a radar system.

38. The apparatus of claim 36, wherein said radar system includes an automotive radar system, and wherein said at least one transponder is mounted on one of a fixed object and a mobile object.
